(19) United States
(12) Patent Application Publication
(10) Pub. No.: US 2011/0308338 A1
(43) Pub. Date: Dec. 22, 2011

(54) FORCE TRANSFER ASSEMBLY

(76) Inventor: Floyd A. SCHLUCKEBIER, Vassar, MI (US)

(21) Appl. No.: 13/165,895

(22) Filed: Jun. 22, 2011

Related U.S. Application Data
(60) Provisional application No. 61/357,387, filed on Jun. 22, 2010.

(51) Int. Cl. F16H 19/02

(52) U.S. Cl. 74/89.2

(57) ABSTRACT

A force transfer assembly that can transfer force at various angles and through relatively small bend radii includes a roller chain constrained in a raceway channel. The configuration provides multi-dimensional support so that a roller chain assembly, typically constrained to tensile loading, may also be used for compressive loading. A method for transmitting force along a non-linear path includes configuring a raceway channel having an upper raceway surface and a lower raceway surface, securing a chain assembly into the raceway channel between the upper raceway surface and the lower raceway surface with at least one lateral securing mechanism, and applying a tensile or compressive force to one end of the chain assembly in order to have the chain assembly transfer the tensile or compressive force to the other end of the chain assembly.

### CROSS-REFERENCE TO RELATED APPLICATIONS

This application claims the priority of U.S. Provisional Patent Application No. 61/357,387, filed Jun. 22, 2010, the entire specification, claims and drawings of which are incorporated herein by reference.

### BACKGROUND

1. Field

Aspects of the present invention relate to a force transfer assembly, and, in particular, to an assembly that effectively transmits loads through various angles in order to effectuate motion in a direction different from that of the axis of applied force.

2. Description of the Related Art

Conventional motion transfer assemblies, such as a Bowden cable, a bell crank, and walking beam assemblies, are typically used for mechanically transferring an applied force from one axis to a different axis. These types of motion transfer assemblies are commonly used in many applications, such as, for example, aircraft wing panels and/or horizontal stabilizers to mechanically actuate the flight control surfaces, and mechanically actuated steering assemblies.

As shown in FIG. 1, for example, a conventional bell crank assembly 10 typically uses a pivoting L-shaped crank 15 to transmit a force applied in a first direction to an end of the primary arm 20 to a force applied in a second direction by the end of a secondary arm 25. As the end of the primary arm 20 is pulled or pushed, by a cable or tie rod, for example, the crank 15 rotates around the pivot point 22 and forces the secondary arm 25 to likewise push or pull a cable or tie rod attached to the end of the secondary arm 25. In this manner, the applied motion along an original axis may be transferred through almost any angle to a secondary axis of motion.

The structure of conventional motion transfer assemblies, comprised of various mechanical linkages, pulleys, and cranks, for example, is often complicated and requires complex tooling to manufacture. Additionally, conventional motion transfer assemblies have various limitations, including being unable to transfer force through relatively small bend radii, as is often the case with Bowden cables, or having an extremely limited range of motion, as is the case with bell crank assemblies. As such, there exists a need for a force transfer assembly that provides the benefits of conventional assemblies while enabling a simpler mounting structure, providing an enhanced ability to transfer force at various angles, including through relatively small bend radii, and providing increased range of motion.

### SUMMARY

A force transfer assembly that can transfer force at various angles and through relatively small bend radii includes a roller chain assembly constrained in a raceway channel. The configuration provides multi-dimensional support so that a roller chain assembly, typically constrained to tensile loading, may also be used for compressive loading.

The advantages of the force transfer assembly described herein include relatively low friction, low hysteresis, a simple mounting structure relative to what is required for bell cranks, walking beams, or other similar devices, small radii for force transmittal relative to that possible with a Bowden cable, for example, and smaller space requirements for installation and actuation while permitting increased range of motion. In addition, because roller chains are highly automated production items, the cost for manufacture of the present invention is lower compared to other conventional force transfer devices.

In accordance with certain aspects of the present invention, the force transfer assembly may include a chain assembly having a first end and a second end, and a raceway channel assembly having a raceway channel with an upper raceway surface and a lower raceway surface and at least one lateral securing mechanism, wherein the chain assembly is secured in the raceway channel via the upper raceway surface, the lower raceway surface, and the at least one lateral securing mechanism, and wherein a tensile or compressive force applied to one of the first end or the second end of the chain assembly is transferred to the other of the first end or the second end of the chain assembly via the chain assembly constrained in the raceway channel assembly.

It is understood that other aspects of a force transfer assembly will become readily apparent to those skilled in the art from the following detailed description, wherein it is shown and described only exemplary configurations of a force transfer assembly. As will be realized, the invention includes other and different aspects of a force transfer assembly and the various details presented throughout this disclosure are capable of modification in various other respects, all without departing from the spirit and scope of the invention. Accordingly, the drawings and the detailed description are to be regarded as illustrative in nature and not restrictive.

### BRIEF DESCRIPTION OF THE FIGURES

FIG. 1 is a perspective view of a conventional motion transfer assembly;

FIG. 2 is plan view of a force transfer assembly, in accordance with aspects of the present invention;

FIG. 3 is a cross sectional view along line A-A of the force transfer assembly shown in FIG. 2, in accordance with aspects of the present invention;

FIG. 4 is a top view of a raceway channel assembly, in accordance with aspects of the present invention; and

FIG. 5 is a side plan view of the raceway channel assembly of FIG. 4, in accordance with aspects of the present invention.

### DETAILED DESCRIPTION

The present invention is described more fully hereinafter with reference to the accompanying drawings, in which various aspects of a force transfer assembly are shown. This invention, however, may be embodied in many different forms and should not be construed as limited by the various aspects of the force transfer assembly presented herein. The detailed description of the force transfer assembly is provided below so that this disclosure will be thorough and complete, and will fully convey the scope of the present invention to those skilled in the art.

The detailed description may include specific details for illustrating various aspects of a force transfer assembly. However, it will be apparent to those skilled in the art that the invention may be practiced without these specific details.

Various aspects of a force transfer assembly may be illustrated by describing components that are coupled together. As used herein, the term “coupled” is used to indicate either a direct connection between two components or, where appropriate, an indirect connection to one another through intervening or intermediate components. In contrast, when a component is referred to as being “directly coupled” to another component, there are no intervening elements present.

Relative terms such as “lower” or “bottom” and “upper” or “top” may be used herein to describe one element's relationship to another element illustrated in the drawings. It will be understood that relative terms are intended to encompass different orientations of an apparatus in addition to the orientation depicted in the drawings. By way of example, if an apparatus in the drawings is turned over, elements described as being on the “bottom” side of the other elements would then be oriented on the “top” side of the other elements. The term “bottom” can therefore encompass both an orientation of “bottom” and “top” depending on the particular orientation of the apparatus.

Various aspects of a force transfer assembly may be illustrated with reference to one or more exemplary embodiments. As used herein, the term “exemplary” means “serving as an example, instance, or illustration,” and should not necessarily be construed as preferred or advantageous over other embodiments of a force transfer assembly disclosed herein.

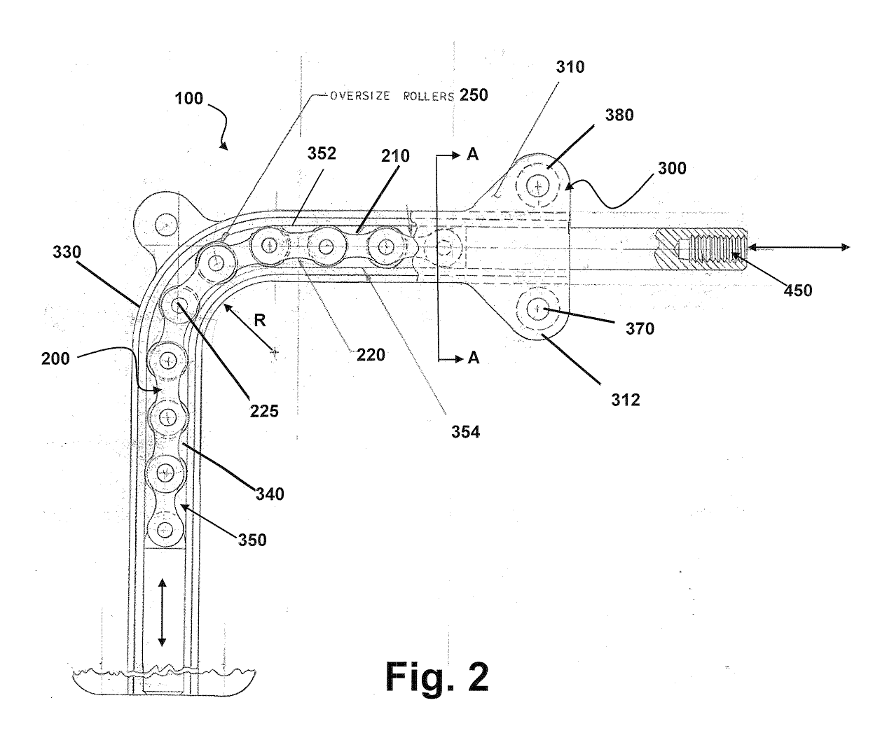

As shown in FIG. 2, a force transfer assembly 100 includes a roller chain assembly 200 provided in a raceway channel assembly 300. The roller chain assembly 200 may have alternating inner links 210 coupled together by alternating outer links 220. The inner links 210 may each have an inner and an outer plate connected by two sleeves or bushings, for example, which may be integrally formed with the inner and outer plates. Similarly, the outer links 220 may include inner and outer plates that are connected together by mounting posts 225 which pass through the sleeves or bushings of the inner links 210 and couple the chain links 210 and 220 together. In accordance with another aspect of the present invention, the mounting posts 225 may directly couple the inner and outer plates of the inner links 210 to the inner and outer plates of the outer links 220 without separate bushings. In accordance with aspects of the present invention, oversized rollers 250 may be rotatably positioned on each of the mounting posts 225. The size of the roller chain assembly 200 may be the same as that of any conventional roller chain, depending on the working load to be imparted to the chain, including chain sizes from 25 to 240 per the ANSI B29-1 roller chain standard sizes.

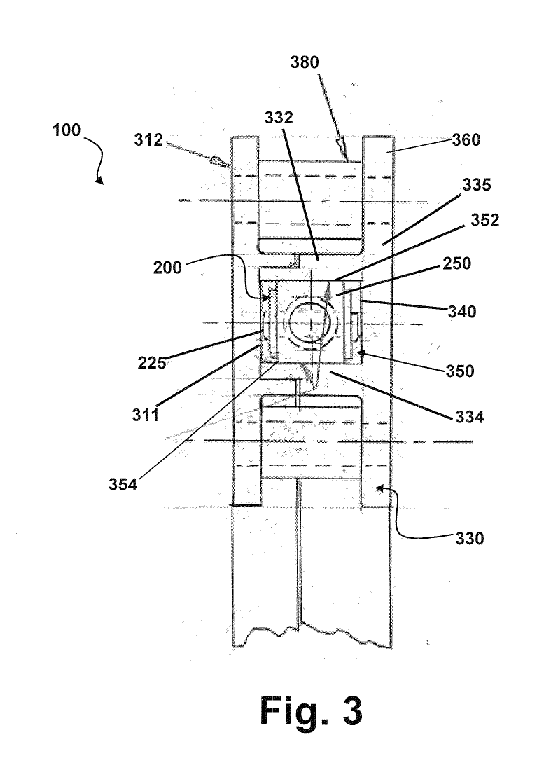

As shown in FIGS. 2 and 3, the raceway channel assembly 300 may include a removable cover 310 coupled to a raceway support structure 330. An upper raceway wall 332 and a lower raceway wall 334 may extend from a base plate portion 335 of the raceway support structure 330 to form a raceway channel 350. The upper and lower raceway walls 332 and 334, respectively, provide an upper raceway surface 352 and a lower raceway surface 354 for rotatably securing the oversized rollers 250 into the raceway channel 350. As shown in FIG. 3, when the removable cover 310 is secured to the raceway support structure 330, the roller chain assembly 200 is laterally secured within the raceway channel 350 between a cover channel wall 311 and a raceway channel wall 340 with the oversized rollers 250 effectively secured between the upper raceway surface 352 and the lower raceway surface 354.

Alternatively, in accordance with another aspect of the present invention, the raceway support structure 330 may be mounted directly against a flat surface, for example, with the open portion of the raceway channel 350 against the flat surface. In this manner, the cover 310 is not required as the roller chain assembly 200 may be laterally secured in the raceway channel 350 between the raceway channel wall 340 and the flat mounting surface. The raceway channel assembly 300 may be formed from a variety of materials and processes suitable for the loads to be encountered, including, for example, sand casting, permanent mold casting, investment casting, die casting, injection molding, compression molding, and cold forming or forging.

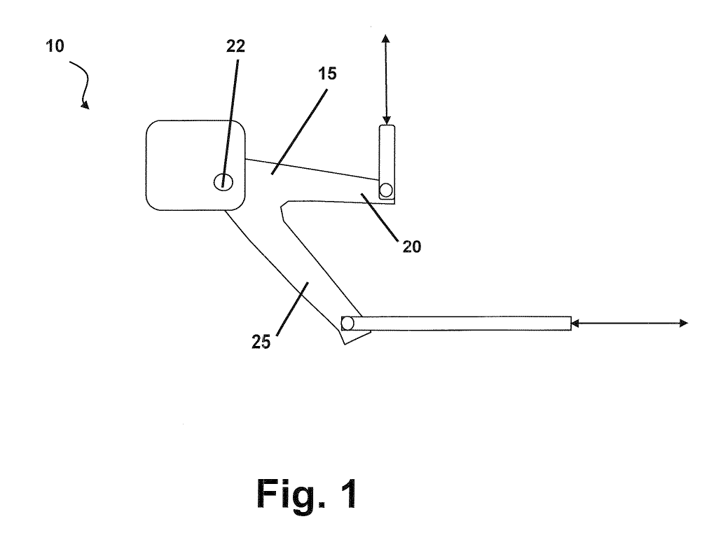

With the roller chain assembly 200 secured in the raceway channel 350, the oversize rollers 250 prevent the chain links 210 and 220 from contacting the upper and lower raceway surfaces 352 and 354, while the channel walls 311 and 340 prevent the chain links 210 and 220 from lateral buckling. In this manner, the roller chain assembly 200 is effectively supported and is capable of transmitting tensile, as well as compressive, forces without failure or buckling. The oversize rollers 250 constrained in the raceway channel 350 provide a low friction means for transferring an applied tensile or compressive force from one end of the assembly to the other. Moreover, unlike the bell crank assembly of FIG. 1, which is limited to a range of motion equal to the travel distance of the rotating arm, the constrained chain may be actuated over much greater distances while maintaining the tensile and compressive structural integrity required for motion in either direction.

As shown in FIG. 2, the raceway channel assembly 300 may be formed with relatively sharp bends, having a small radius of curvature R, for example, which allows the transfer of force from one axis to another through a smaller radii compared to that of conventional power transfer mechanisms. The radius of curvature R may be limited only by the tolerances involved with the fit of the oversized rollers 250 in the raceway channel 350, for example. In another aspect of the present invention, the raceway channel 350 may be sealed to permit lubrication fluid to be stored internally to the raceway channel assembly 300.

The cover 310 may be formed with flanges 312 for securing to raceway attachment flanges 360 provided on the raceway support structure 330. Attachment devices 370, which may be any suitable attachment mechanism for removably securing the cover 310 to the raceway support structure 330, such as bolts or screws, for example, may secure the cover 310 to the raceway support structure 330, and may simultaneously couple the raceway support structure 330 to an environmental structure. Spacers 380 may be provided between the flanges 312 and 360 for additional support.

The connection of the roller chain assembly 200 to an external mechanism 450 may be accomplished by a variety of methods, including threaded connection (as shown) or forks, swaging, cold forming, welding, soldering, injection molding, and magna forming, just to name a few. The external load applied to the force transfer assembly 100 to be transmitted may be, for example, with a hydraulic cylinder, pneumatic cylinder, vacuum cylinder, lever, electric screw jack assembly, electric solenoid, crank and connecting rod, or any other suitable mechanism for applying a force where the force is to be transferred along a non-linear path.

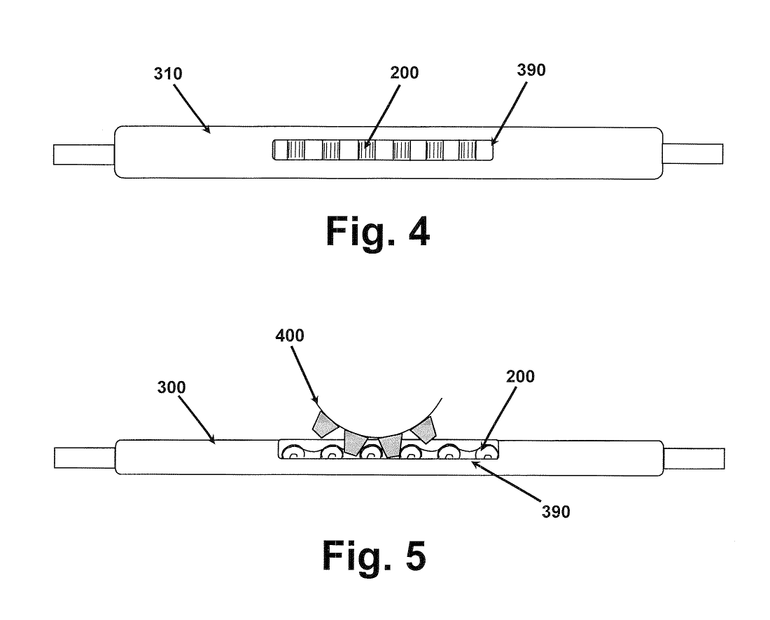

As shown in FIGS. 4 and 5, in accordance with aspects of the present invention, the raceway channel assembly 300 may include a slot 390 provided in the cover 310. In this manner, access may be provided to the constrained roller chain assembly 200 for a sprocket assembly 400, for example, to provide multidirectional control of the roller chain assembly 200 inside the raceway channel assembly 300. Because the roller chain assembly 200 is not limited to tensile loads only, the assembly may be used as shown, for example, to replace aspects of various steering assemblies in a wide array of vehicles, with the advantage that the static linkages often employed in conventional, rack and pinion steering systems may be replaced. In addition, one is not limited to designing vehicle structural features to avoid the static linkages of the steering system. Rather, one may form the linkages, i.e., the raceway channel assembly 300, to transfer force around the structural features.

In accordance with yet other aspects of the present invention, a chain assembly may be provided that does not use oversized rollers. Preferably for use in structures requiring non-frequent, low-friction loads, a hardened raceway channel, such as one formed from heat-treated steel or aluminum, for example, may be provided to withstand the direct load of a chain assembly without rollers. The same advantages of a constrained roller chain assembly are provided in the structure employing a chain assembly without rollers, except that a substantially higher frictional load may require the use of the hardened raceway.

The previous description is provided to enable any person skilled in the art to practice the various embodiments described herein. Various modifications to these embodiments will be readily apparent to those skilled in the art, and the generic principles defined herein may be applied to other embodiments. All structural and functional equivalents to the elements of the various embodiments described throughout this disclosure that are known or later come to be known to those of ordinary skill in the art are expressly incorporated herein by reference.

What is claimed is:

1. A force transfer assembly for transferring an applied force, comprising:
a chain assembly having a first end and a second end; and
a raceway channel assembly comprising:
a raceway channel having an upper raceway surface and a lower raceway surface, and
at least one lateral securing mechanism;
wherein the chain assembly is secured in the raceway channel via the upper raceway surface, the lower raceway surface, and the at least one lateral securing mechanism, and
wherein a tensile or a compressive force applied to one of the first end or the second end of the chain assembly is transferred to the other of the first end or the second end of the chain assembly via the chain assembly constrained in the raceway channel assembly.

2. The assembly according to claim 1, further comprising:
a raceway support structure having a base plate portion, wherein the lateral securing mechanism comprises the base plate portion.

3. The assembly according to claim 2, wherein the raceway support structure further comprises an upper raceway wall and a lower raceway wall, each wall extending laterally from the base plate portion a distance greater than the lateral width of the chain assembly, and wherein the upper raceway wall and the lower raceway wall respectively comprise the upper raceway surface and the lower raceway surface.

4. The assembly according to claim 3, wherein the lateral securing mechanism further comprises a removable cover secured to the raceway support structure and enclosing the raceway channel.

5. The assembly according to claim 4, wherein the cover is formed with a cover flange for securing the cover to the raceway support structure via an attachment device.

6. The assembly according to claim 5, further comprising a spacer provided between the cover flange and the raceway support structure.

7. The assembly according to claim 1, wherein the chain assembly comprises chain links connected together by mounting posts and rollers rotatably mounted on the mounting posts.

8. The assembly according to claim 7, wherein the rollers are sized to prevent the chain links from contacting the upper and lower raceway surfaces.

9. The assembly according to claim 1, further comprising a lubrication fluid, wherein the raceway channel is sealed for containment of the lubrication fluid therein.

10. The assembly according to claim 1, further comprising an external mechanism connected to one of the first end or the second end, which is acted upon by the applied tensile or compressive force.

11. The assembly according to claim 10, further comprising a force mechanism for generating the applied tensile or compressive force.

12. The assembly according to claim 11, wherein the force mechanism is a hydraulic cylinder, pneumatic cylinder, vacuum cylinder, lever, electric screw jack assembly, electric solenoid, or a crank and connecting rod assembly.

13. The assembly according to claim 4, further comprising a sprocket, wherein a slot is provided in the cover allowing the sprocket to access the constrained chain assembly to provide multidirectional control of the chain assembly inside the raceway channel via the sprocket.

14. The assembly according to claim 1, wherein the raceway channel is comprised of a hardened material.

15. The assembly according to claim 1, wherein at least a portion of the raceway channel is non-linear.

16. A method of transmitting force along a non-linear path, comprising:
configuring a raceway channel having an upper raceway surface and a lower raceway surface;
securing a chain assembly into the raceway channel between the upper raceway surface and the lower raceway surface with at least one lateral securing mechanism; and
applying a tensile or compressive force to one end of the chain assembly in order to have the chain assembly transfer the tensile or compressive force to the other end of the chain assembly.

17. The method of claim 16, further comprising:
configuring the chain assembly with oversized rollers, the oversized rollers rotatably contacting the upper and lower raceway surfaces.

18. The method of claim 16, further comprising:
sealing the raceway channel; and
providing a lubrication fluid in the sealed raceway channel.

19. The method of claim 16, further comprising:
hardening at least one of the upper raceway surface or the lower raceway surface.

20. The method of claim 16, further comprising:
connecting a force generating mechanism to one end of the chain assembly and connecting an external mechanism to the other end of the chain assembly for generating and receiving, respectively, the applied tensile or compressive force via the chain assembly constrained in the raceway channel.
